(19) United States
(12) Patent Application Publication
(10) Pub. No.: US 2026/0188114 A1
(43) Pub. Date: Jul. 2, 2026

(54) MULTI-USER NAVIGATION SYSTEM AND INFORMATION PROCESSING METHOD

(71) Applicant: Sony Group Corporation, Tokyo (JP)

(72) Inventor: Justinas MISEIKIS, Stuttgart (DE)

(73) Assignee: Sony Group Corporation, Tokyo (JP)

(21) Appl. No.: 19/132,374

(22) PCT Filed: Dec. 8, 2023
(86) PCT No.: PCT/EP2023/084909

§ 371 Date: May 23, 2025

(30) Foreign Application Priority Data
Dec. 9, 2022 (EP) 22212609.6

(51) Int. Cl. G08G 1/0965; G08G 1/01; G08G 1/0967; G08G 1/0968; H04W 4/46; H04W 4/90

(52) U.S. Cl. CPC G08G 1/0965; G08G 1/0133; G08G 1/096791; G08G 1/096844; H04W 4/46; H04W 4/90

(57) ABSTRACT

A multi-user navigation system, wherein the multi-user navigation system includes: an emergency navigation device associated with an emergency vehicle, wherein the emergency navigation device is configured to: determine, based on an obtained start location of the emergency vehicle and an obtained destination of the emergency vehicle, emergency route data representing an emergency route of the emergency vehicle from the start location to the destination, transmit, via a mobile telecommunications system, an emergency route message to a plurality of navigation devices each being associated with a vehicle that is within a predetermined distance to the route of the emergency vehicle; and the plurality of navigation devices, wherein each navigation device is configured to receive the emergency route message which indicates that the emergency vehicle approaches.

### TECHNICAL FIELD

The present disclosure generally pertains to a multi-user navigation system and an information processing method for a multi-user navigation system.

### TECHNICAL BACKGROUND

Current navigation systems, both in-car and independently running on mobile communication devices or dedicated navigation devices, are typically connected to a mobile telecommunications system and have information about real-time traffic.

However, during heavy traffic, like busy roads or rush-hour, the roads may get congested and emergency vehicles may not be able to pass quickly. In some cases, the cause may be that once the driver hears sirens and sees the emergency vehicle, the driver may not know which direction to move out of the way or might not have enough space to move out of the way and clear the road.

Although there exist techniques for navigation systems, it is generally desirable to improve the existing techniques.

### SUMMARY

According to a first aspect the disclosure provides a multi-user navigation system, comprising:
an emergency navigation device associated with an emergency vehicle, wherein the emergency navigation device is configured to:
   determine, based on an obtained start location of the emergency vehicle and an obtained destination of the emergency vehicle, emergency route data representing an emergency route of the emergency vehicle from the start location to the destination,
   transmit, via a mobile telecommunications system, an emergency route message to a plurality of navigation devices each being associated with a vehicle that is within a predetermined distance to the route of the emergency vehicle; and
the plurality of navigation devices, wherein each navigation device is configured to receive the emergency route message which indicates that the emergency vehicle approaches.

According to a second aspect the disclosure provides an information processing method for a multi-user navigation system, comprising:
determining, based on an obtained start location of an emergency vehicle and an obtained destination of the emergency vehicle, emergency route data representing an emergency route of the emergency vehicle from the start location to the destination;
transmitting, via a mobile telecommunications system, an emergency route message to a plurality of navigation devices each being associated with a vehicle that is within a predetermined distance to the route of the emergency vehicle; and
receiving the emergency route message which indicates that the emergency vehicle approaches.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates an embodiment of a multi-user navigation system;

FIG. 2 schematically illustrates in a flow diagram an embodiment of an information processing method; and

FIG. 3 schematically illustrates in a block diagram a multi-purpose computer which can be used for implementing an emergency navigation device and a navigation device.

### DETAILED DESCRIPTION OF EMBODIMENTS

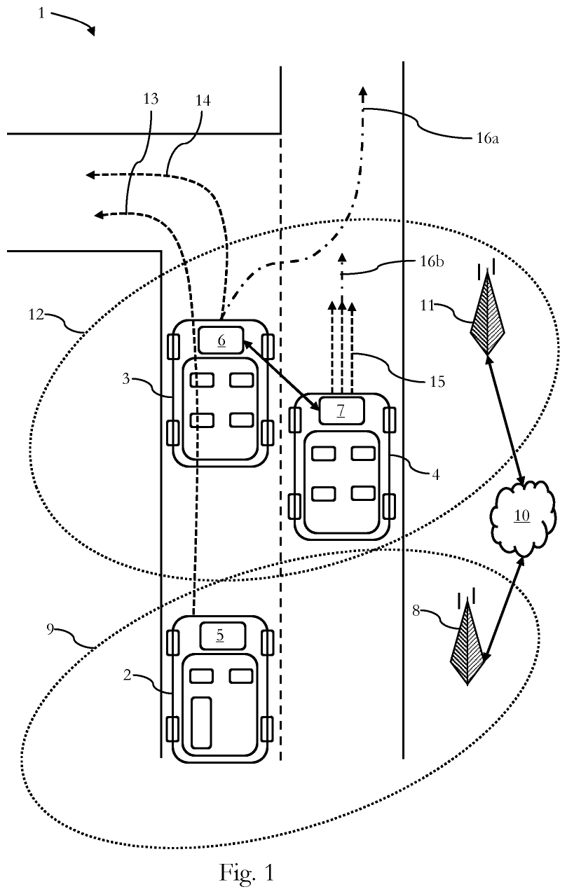

Before a detailed description of the embodiments under reference of FIG. 1 is given, general explanations are made.

As mentioned in the outset, during heavy traffic, like busy roads or rush-hour, the roads may get congested and emergency vehicles may not be able to pass quickly. In some cases, the cause may be that once the driver hears sirens and sees the emergency vehicle, the driver may not know which direction to move out of the way or might not have enough space to move out of the way and clear the road.

Current navigation systems, both in-car and independently running on mobile communication devices or dedicated navigation devices, are typically connected to a mobile telecommunications system and have information about real-time traffic.

It has been recognized that navigation devices may be used to warn the drivers about an approaching emergency vehicle and to provide guidance on where and how to move out of the way in the most efficient manner to clear up the road.

Hence, some embodiments pertain to a multi-user navigation system, wherein the multi-user navigation system includes:
an emergency navigation device associated with an emergency vehicle, wherein the emergency navigation device is configured to:
   determine, based on an obtained start location of the emergency vehicle and an obtained destination of the emergency vehicle, emergency route data representing an emergency route of the emergency vehicle from the start location to the destination,
   transmit, via a mobile telecommunications system, an emergency route message to a plurality of navigation devices each being associated with a vehicle that is within a predetermined distance to the route of the emergency vehicle; and
the plurality of navigation devices, wherein each navigation device is configured to receive the emergency route message which indicates that the emergency vehicle approaches.

Each of the emergency navigation device, the plurality of navigation devices, the emergency vehicle and each vehicle may include circuitry configured to achieve the functions as described herein.

The circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like or a combination thereof.

The functionality may be implemented by software executed by a processor such as a microprocessor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include data storage capabilities to store data such as memory which may be based on semiconductor storage technology (e.g., RAM, EPROM, etc.) or magnetic storage technology (e.g., a hard disk drive) or the like.

The circuitry may include a data bus for receiving and transmitting data over the data bus. The circuitry may implement communication protocols for receiving and transmitting the data over the data bus. The data bus may be or may be based on a Controller Area Network (CAN) bus, an I²C (Inter-Integrated Circuit) interface, or the like.

The circuitry may include a network interface to communicate wireless with an external computer network, e.g., via a mobile telecommunications network (which may be based on UMTS, LTE, LTE-A, or a NR, 5G system or the like). The circuitry may include a wireless interface to support wireless data exchange using a wireless communication protocol (e.g., Bluetooth®, Wi-Fi®, ZigBee®, NFC (“Near Field Communication”)). The circuitry may further be configured to support vehicle-to-vehicle (“V2V”) communication.

The circuitry may have further a receiver for a global navigation satellite system (“GNSS”) such as a GPS (“Global Positioning System”) receiver.

In some embodiments, each vehicle includes one or more cameras and one or more distance measurement devices (e.g., a radar device, a time-of-flight device, or the like) to obtain environment data. The environment data indicating a surrounding of the respective vehicle.

For example, the emergency vehicle may set the emergency navigation device (e.g., set by the driver, the emergency vehicle crew or remotely) to the destination which determines the emergency navigation route including the timeline of the planned drive based on an estimated realistic speed of the emergency vehicle (which does not need to comply with speed limits) such that it estimates the timeline along the emergency route and possible traffic jams and bottleneck spots along the emergency route.

For vehicles with connected in-car or independent navigation devices, for instance, notification of the incoming emergency vehicle may be shown together with the instructions to follow. Instructions may include a change in the vehicle route, pulling over to indicated side of the road, stopping for certain period of time, slowing down and moving to one side of the road or the like.

Hence, in some embodiments, the emergency route message includes a driving instruction to output via the plurality of navigation devices.

In some embodiments, each of the plurality of navigation devices is configured to refine the driving instruction based on vehicle route data representing a vehicle route associated with the respective vehicle.

For example, the driving instruction may only indicate to clear up the road because an emergency vehicle approaches, and the navigation device may determine an alternative route to the vehicle route to refine the driving instruction and to clear up the emergency route.

Moreover, in some embodiments, refining the driving instruction is further based on obtained environment data representing an environment of the respective vehicle.

For example, the driving instruction may only indicate to move to one side of the road and the obtained environment data may indicate that it is only possible to move to the right side due to traffic jam such that the navigation device of the respective vehicle refines the driving instruction based on the environment data by specifying to which side to move.

In some embodiments, the emergency route message includes the emergency route data.

In some embodiments, each of the plurality navigation devices is configured to overlay the emergency route on a displayed vehicle route associated with the respective vehicle.

Accordingly, the driver of the respective vehicle knows the emergency route in relation to the vehicle route.

In some embodiments, the emergency navigation device is configured to transmit, via the mobile telecommunications system, the emergency route message in a radio cell covering a current location of the emergency navigation device and in each radio cell adjacent to the radio cell covering at least a part of the emergency route.

In such embodiments, the emergency route message includes the emergency route data and, thus, the serving base station establishing the radio cell covering the current location of the emergency navigation device is able to determine the adjacent radio cells which cover the next part of the emergency route and is able to transmit the emergency route message to base stations establishing the adjacent radio cells via a wired network connection between the base stations. In this way, the emergency route message is transmitted to vehicles which are effected by the approaching emergency vehicle. In such embodiments, each base station transmits the emergency route message by broadcasting the emergency route message.

It has further been recognized that connected infrastructure, such as traffic lights, road and intersection cameras and speed cameras may be integrated in the multi-user navigation system. For example, traffic lights may adjust the traffic flow to make sure the traffic flows and avoids standstill on the road where the emergency vehicle will be driving, while stopping intersecting roads/streets. Moreover, for instance, traffic cameras may be used to evaluate the traffic situation. Additionally, speed and red-light cameras may be disabled for a certain period to avoid capturing emergency vehicles themselves or the vehicles which might cross the stop line when moving out of the way to allow the emergency vehicle to pass.

Thus, in some embodiments, the emergency navigation device is configured to transmit, via the mobile telecommunications system, the emergency route message to infrastructure devices along the emergency route.

In some embodiments, the emergency navigation device is configured to transmit, via the mobile telecommunications system, the emergency route message to other emergency navigation devices each being associated with another emergency vehicle that is within a predetermined distance to the route of the emergency vehicle.

In some embodiments, the emergency navigation device is configured to transmit, via the mobile telecommunications system, the emergency route message to a plurality of public transport navigation devices each being associated with a public transport vehicle that is within a predetermined distance to the route of the emergency vehicle.

It has further been recognized that the vehicles which are within a predetermined distance to the emergency route may perform a driving maneuver in a coordinated manner to efficiently clear up the emergency route.

Hence, in some embodiments, each of the plurality of navigation devices is configured to determine, via vehicle-to-vehicle communications provided by the respective vehicle, a cooperative driving maneuver with the other of the plurality of navigation devices in response to the emergency route message for clearing the emergency route.

Each navigation device may wirelessly connect to the vehicle, for example, the navigation device may be a smartphone and may connect via a wireless communication protocol to the vehicle (e.g., Bluetooth®) to use the vehicle-to-vehicle communication functions of the vehicle which relays the data to the smartphone via the wireless connection. Each navigation device may be an in-vehicle navigation device and, thus, pre-installed and connected with the vehicle and, thus, may use the vehicle-to-vehicle communication functions provided by the vehicle.

Each navigation device may take int account several factors:

In some embodiments, the cooperative driving maneuver is based on the emergency route message (including the emergency route data).

In some embodiments, the cooperative driving maneuver is further based on vehicle route data representing a vehicle route associated with the respective vehicle.

In some embodiments, the cooperative driving maneuver is further based on obtained environment data representing an environment of the respective vehicle.

In some embodiments, the cooperative driving maneuver is further based on obtained traffic data.

In some embodiments, the cooperative driving maneuver includes a driving maneuver for each vehicle for output as a driving instruction by the respective navigation device of the plurality of navigation devices.

In some embodiments, for determining the cooperative driving maneuver, each navigation device determines at first one or more possible driving maneuver for the associated vehicle, for example, based on at least one of the emergency route message (including the emergency route data), vehicle route data representing a vehicle route associated with the respective vehicle, obtained environment data representing an environment of the respective vehicle and obtained traffic data.

In such embodiments, the list of the one or more driving maneuvers is transmitted, via vehicle-to-vehicle communications, to the other vehicles and then to the other navigation devices.

In such embodiments, each navigation device selects one driving maneuver from the list of one or more driving maneuvers based on the one or more driving maneuvers of the other vehicles.

In such embodiments, the selection may be based on predetermined rules or may be learned (e.g., via machine learning). The predetermined rules may be obtained from traffic simulations and the learning may be based on supervised or unsupervised learning strategies.

Some embodiments pertain to an information processing method for a multi-user navigation system, wherein the information processing method includes:
determining, based on an obtained start location of an emergency vehicle and an obtained destination of the emergency vehicle, emergency route data representing an emergency route of the emergency vehicle from the start location to the destination;
transmitting, via a mobile telecommunications system, an emergency route message to a plurality of navigation devices each being associated with a vehicle that is within a predetermined distance to the route of the emergency vehicle; and
receiving the emergency route message which indicates that the emergency vehicle approaches.

In some embodiments, information from navigation devices of the vehicles on the road are combined and/or prediction of vehicle movement is made.

In some embodiments, the vehicle route for the drivers is adjusted to avoid clogging the road by the time the emergency vehicle will be approaching the location of the vehicle. For example, cars may be directed to turn to smaller roads or stop for the short time.

In some embodiments, the emergency route message suggests the drivers which side to move to when the emergency vehicle is approaching.

In some embodiments, the vehicle is an autonomous vehicle which adjusts the driving trajectory according to the determined driving maneuver.

In some embodiments, the vehicle gives the access to front and back-facing cameras on the vehicles and road cameras, vehicle locations and the drivable area may be estimated to provide the best driving maneuvers for the vehicles to clear the road for the emergency vehicle.

In some embodiments, the vehicle includes a connected vehicle system (e.g., Android Auto® or Apple CarPlay®) may serve as an integration of mobile communications devices with the vehicle system.

In some embodiments, the driver is notified with an indication of approaching emergency vehicle and what action needs to be taken.

In some embodiments, the indication is shown on digital displays or heads-up display (HUD) or audio indications are used.

This may help distracted drivers who might not notice emergency vehicle (for example, when listening to loud music).

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Some embodiments pertain to a mobile telecommunications system, wherein the mobile telecommunications system is configured to broadcast an obtained emergency route message.

In some embodiments, the mobile telecommunications system is configured to determine, based on the obtained emergency route message including emergency route data representing an emergency route of an emergency vehicle, a radio cell in which the obtained emergency route is broadcasted.

Returning to FIG. 1, which schematically illustrates an embodiment of a multi-user navigation system 1, which is discussed in the following under reference of FIG. 1.

The multi-user navigation system includes an emergency navigation device 5 associated with an emergency vehicle 2, a first navigation device 6 associated with a first vehicle 3, a second navigation device 7 associated with a second vehicle 4, a first base station 8 establishing a first radio cell 9 and a second base station 11 establishing a second radio cell 12 adjacent to the first radio cell 9.

The first base station 8 and the second base station 11 communicate with each other by wired network 10, as a part of a mobile communications system.

The first vehicle 3 and the second vehicle 4 include at least one of a camera and a distance measurement device (not shown in FIG. 1) to obtain environment data representing a surrounding of the vehicle 3 and 4, respectively.

For the sake of illustration only two vehicles 3 and 4 are shown in FIG. 1 without limiting the disclosure in this regard.

A driver of the emergency vehicle 2 inputs a destination of the emergency vehicle 2 (e.g., a hospital or a location where an accident occurred or the like). The emergency navigation device 5 determines the start location of the emergency vehicle 2 using a receiver of a GNSS (e.g., GPS).

The emergency navigation device 5 determines emergency route data representing an emergency route 13 of the emergency vehicle 2 from the start location to the destination.

The emergency navigation device 5 transmits an emergency route message to the first base station 8, wherein the first base station 8 covers a current location of the emergency vehicle 2.

The first base station 8 transmits the emergency route message, via the wired network 10, to the second base station 11.

The second base station 11 broadcasts the emergency route message which is received by the first navigation device 6 and the second navigation device 7, wherein the emergency route message indicates that the emergency vehicle 2 approaches.

According to some first embodiments, the emergency route message includes a driving instruction which is output by the first and the second navigation device 6 and 7, respectively, wherein the driving instruction indicates to clear the road for the emergency vehicle 2.

In this way, each vehicle effected by the approaching emergency vehicle 2 is addressed.

According to some second embodiments, the emergency route message includes the emergency route data.

At first, each of the first and second navigation device 6 and 7, respectively, overlay the emergency route on a displayed first vehicle route 14 and a second vehicle route 15, respectively.

In response to the emergency route message, the first navigation device 6 and the second navigation device 7 determine, via vehicle to-vehicle communications (as illustrated by the arrow between the first navigation device 6 and the second navigation device 7), a cooperative driving maneuver (16a, 16b) for clearing the emergency route 13.

In order to determine the cooperative driving maneuver (16a, 16b), the first navigation device 6 obtains environment data of the vehicle 3 and first vehicle route data representing the first vehicle route 14.

In order to determine the cooperative driving maneuver (16a, 16b), the second navigation device 7 obtains environment data of the vehicle 4 and second vehicle route data representing the second vehicle route 15.

The first navigation device 6 determines that the emergency route 13 and the first vehicle route 14 overlap and that the only possible first driving maneuver 16a to clear up the road is to move from the left lane to the right lane.

However, based on the environment data of vehicle 3, the first navigation device 6 determines that the second vehicle 4 is moving on the right lane.

Then, the first navigation device 6 transmits, via the vehicle-to-vehicle communication, the only possible first driving maneuver 16a to the second navigation device 7.

The second navigation device 7 determines, based on the environment data of the second vehicle 4, that the first vehicle 3 is moving on the left lane.

Moreover, the second navigation device 7 receives, via the vehicle-to-vehicle communications, the only possible first driving maneuver 16a from the first vehicle 3.

The second navigation device 7 itself may previously determine that the associated second vehicle 4 may be able to perform various second driving maneuvers such as to stop, decelerate, maintain or accelerate.

However, based on a predetermined rule requiring that, when another vehicle such as the first vehicle 3 has only one possible first driving maneuver 16a left as an option to clear the road, the second vehicle 4 should select a second driving maneuver 16b which allows the first vehicle 3 to perform the only left first driving maneuver 16a.

Hence, the second navigation device 7 determines that the second driving maneuver 16b of the associated second vehicle 4 should be to decelerate to let the first vehicle 3 enough space to move to the right lane (as illustrated by one dashed arrow for the second driving maneuver 16b instead of three for the second vehicle route 15).

As the only option, the first navigation device 6 determines that the first driving maneuver 16a should be performed to move from the left lane to the right lane.

The first navigation device 6 outputs the first driving maneuver 16a as a driving instruction to a driver of the first vehicle 3.

The second navigation device 7 outputs the second driving maneuver 16b as a driving instruction to a driver of the second vehicle 4.

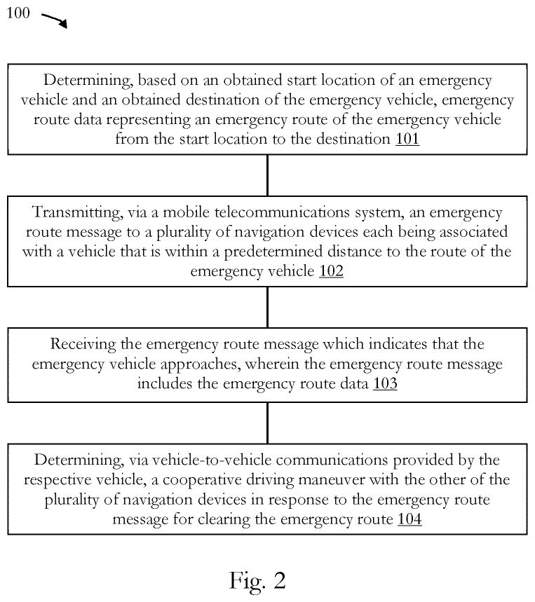

FIG. 2 schematically illustrates in a flow diagram an embodiment of an information processing method 100.

The information processing method 100 may be performed by the multi-user navigation system 1 of FIG. 1.

At 101, based on an obtained start location of an emergency vehicle and an obtained destination of the emergency vehicle, emergency route data are determined representing an emergency route of the emergency vehicle from the start location to the destination, as discussed herein.

At 102, an emergency route message is transmitted via a mobile telecommunications system to a plurality of navigation devices each being associated with a vehicle that is within a predetermined distance to the route of the emergency vehicle, as discussed herein.

At 103, the emergency route message which indicates that the emergency vehicle approaches is received, wherein the emergency route message includes the emergency route data, as discussed herein.

At 104, via vehicle-to-vehicle communications provided by the respective vehicle, a cooperative driving maneuver is determined with the other of the plurality of navigation devices in response to the emergency route message for clearing the emergency route, as discussed herein.

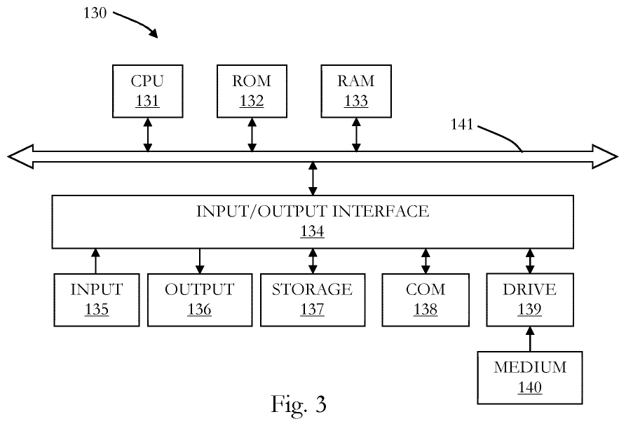

FIG. 3 schematically illustrates in a block diagram a multi-purpose computer 130 which can be used for implementing an emergency navigation device X and a navigation device Y.

The computer 130 can be implemented such that it can basically function as a base station, an emergency navigation device or a navigation device as described herein. The computer has components 131 to 141, which can form a circuitry, such as a circuitry of the emergency navigation device or the navigation device, as described herein.

Embodiments which use software, firmware, programs or the like for performing the methods as described herein can be installed on computer 130, which is then configured to be suitable for the concrete embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as an emergency navigation device or a navigation device.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, etc.), loudspeakers, etc.

The storage 137 can have a hard disk, a solid state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, etc.

The computer 130 may have further a receiver for a global navigation satellite system (“GNSS”) such as a GPS (“Global Positioning System”) receiver when it functions as an emergency navigation device or a navigation device.

It should be noted that the description above only pertains to an example configuration of computer 130. Alternative configurations may be implemented with additional or other sensors, storage devices, interfaces or the like. For example, the communication interface 138 may support other radio access technologies than the mentioned UMTS, LTE and NR.

When the computer 130 functions as a base station, an emergency navigation device or a navigation device, the communication interface 138 can further have a respective air interface (providing, e.g., E-UTRA protocols OFDMA (downlink) and SC-FDMA (uplink)) and network interfaces (implementing for example protocols such as S1-AP, GTP-U, S1-MME, X2-AP, or the like). Moreover, the computer 130 may have one or more antennas and/or an antenna array. The present disclosure is not limited to any particularities of such protocols.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure. Note that the present technology can also be configured as described below.

(1) A multi-user navigation system, wherein the multi-user navigation system includes:
an emergency navigation device associated with an emergency vehicle, wherein the emergency navigation device is configured to:
   determine, based on an obtained start location of the emergency vehicle and an obtained destination of the emergency vehicle, emergency route data representing an emergency route of the emergency vehicle from the start location to the destination,
   transmit, via a mobile telecommunications system, an emergency route message to a plurality of navigation devices each being associated with a vehicle that is within a predetermined distance to the route of the emergency vehicle; and
the plurality of navigation devices, wherein each navigation device is configured to receive the emergency route message which indicates that the emergency vehicle approaches.

(2) The multi-user navigation system of (1), wherein the emergency route message includes a driving instruction to output via the plurality of navigation devices.

(3) The multi-user navigation system of (2), wherein each of the plurality of navigation devices is configured to refine the driving instruction based on vehicle route data representing a vehicle route associated with the respective vehicle.

(4) The multi-user navigation system of (3), wherein refining the driving instruction is further based on obtained environment data representing an environment of the respective vehicle.

(5) The multi-user navigation system of anyone of (1) to (4), wherein the emergency route message includes the emergency route data.

(6) The multi-user navigation system of (5), wherein each of the plurality navigation devices is configured to overlay the emergency route on a displayed vehicle route associated with the respective vehicle.

(7) The multi-user navigation system of (5) or (6), wherein each of the plurality of navigation devices is configured to determine, via vehicle-to-vehicle communications provided by the respective vehicle, a cooperative driving maneuver with the other of the plurality of navigation devices in response to the emergency route message for clearing the emergency route.

(8) The multi-user navigation system of (7), wherein the cooperative driving maneuver is based on the emergency route message.

(9) The multi-user navigation system of (8), wherein the cooperative driving maneuver is further based on vehicle route data representing a vehicle route associated with the respective vehicle.

(10) The multi-user navigation system of (8) or (9), wherein the cooperative driving maneuver is further based on obtained environment data representing an environment of the respective vehicle.

(11) The multi-user navigation system of anyone of (8) to (10), wherein the cooperative driving maneuver is further based on obtained traffic data.

(12) The multi-user navigation system of (7) to (11), wherein the cooperative driving maneuver includes a driving maneuver for each vehicle for output as a driving instruction by the respective navigation device of the plurality of navigation devices.

(13) The multi-user navigation system of (5) to (12), wherein the emergency navigation device is configured to transmit, via the mobile telecommunications system, the emergency route message in a radio cell covering a current location of the emergency navigation device and in each radio cell adjacent to the radio cell covering at least a part of the emergency route.

(14) The multi-user navigation system of anyone of (5) to (13), wherein the emergency navigation device is configured to transmit, via the mobile telecommunications system, the emergency route message to infrastructure devices along the emergency route.

(15) The multi-user navigation system of anyone of (4) to (14), wherein the environment data is obtained from at least one of a camera and a distance measurement device of the respective vehicle.

(16) The multi-user navigation system of anyone of (5) to (15), wherein the emergency navigation device is configured to transmit, via the mobile telecommunications system, the emergency route message to other emergency navigation devices each being associated with another emergency vehicle that is within a predetermined distance to the route of the emergency vehicle.

(17) The multi-user navigation system of anyone of (5) to (16), wherein the emergency navigation device is configured to transmit, via the mobile telecommunications system, the emergency route message to a plurality of public transport navigation devices each being associated with a public transport vehicle that is within a predetermined distance to the route of the emergency vehicle.

(18) An information processing method for a multi-user navigation system, wherein the multi-user navigation system includes:
determining, based on an obtained start location of an emergency vehicle and an obtained destination of the emergency vehicle, emergency route data representing an emergency route of the emergency vehicle from the start location to the destination;
transmitting, via a mobile telecommunications system, an emergency route message to a plurality of navigation devices each being associated with a vehicle that is within a predetermined distance to the route of the emergency vehicle; and
receiving the emergency route message which indicates that the emergency vehicle approaches.

(19) The information processing method of (18), wherein the emergency route message includes the emergency route data.

(20) The information processing method of (19), including:
determining, via vehicle-to-vehicle communications provided by the respective vehicle, a cooperative driving maneuver with the other of the plurality of navigation devices in response to the emergency route message for clearing the emergency route.

(21) A computer program comprising program code causing a computer to perform the method according to anyone of (18) to (20), when being carried out on a computer.

(22) A non-transitory computer-readable recording medium that stores therein a computer program product, which, when executed by a processor, causes the method according to anyone of (18) to (20) to be performed.

1. A multi-user navigation system, comprising:
an emergency navigation device associated with an emergency vehicle, wherein the emergency navigation device is configured to:
determine, based on an obtained start location of the emergency vehicle and an obtained destination of the emergency vehicle, emergency route data representing an emergency route of the emergency vehicle from the start location to the destination,
transmit, via a mobile telecommunications system, an emergency route message to a plurality of navigation devices each being associated with a vehicle that is within a predetermined distance to the route of the emergency vehicle; and
the plurality of navigation devices, wherein each navigation device is configured to receive the emergency route message which indicates that the emergency vehicle approaches.

2. The multi-user navigation system according to claim 1, wherein the emergency route message includes a driving instruction to output via the plurality of navigation devices.

3. The multi-user navigation system according to claim 2, wherein each of the plurality of navigation devices is configured to refine the driving instruction based on vehicle route data representing a vehicle route associated with the respective vehicle.

4. The multi-user navigation system according to claim 3, wherein refining the driving instruction is further based on obtained environment data representing an environment of the respective vehicle.

5. The multi-user navigation system according to claim 1, wherein the emergency route message includes the emergency route data.

6. The multi-user navigation system according to claim 5, wherein each of the plurality navigation devices is configured to overlay the emergency route on a displayed vehicle route associated with the respective vehicle.

7. The multi-user navigation system according to claim 5, wherein each of the plurality of navigation devices is configured to determine, via vehicle-to-vehicle communications provided by the respective vehicle, a cooperative driving maneuver with the other of the plurality of navigation devices in response to the emergency route message for clearing the emergency route.

8. The multi-user navigation system according to claim 7, wherein the cooperative driving maneuver is based on the emergency route message.

9. The multi-user navigation system according to claim 8, wherein the cooperative driving maneuver is further based on vehicle route data representing a vehicle route associated with the respective vehicle.

10. The multi-user navigation system according to claim 8, wherein the cooperative driving maneuver is further based on obtained environment data representing an environment of the respective vehicle.

11. The multi-user navigation system according to claim 8, wherein the cooperative driving maneuver is further based on obtained traffic data.

12. The multi-user navigation system according to claim 7, wherein the cooperative driving maneuver includes a driving maneuver for each vehicle for output as a driving instruction by the respective navigation device of the plurality of navigation devices.

13. The multi-user navigation system according to claim 5, wherein the emergency navigation device is configured to transmit, via the mobile telecommunications system, the emergency route message in a radio cell covering a current location of the emergency navigation device and in each radio cell adjacent to the radio cell covering at least a part of the emergency route.

14. The multi-user navigation system according to claim 5, wherein the emergency navigation device is configured to transmit, via the mobile telecommunications system, the emergency route message to infrastructure devices along the emergency route.

15. The multi-user navigation system according to claim 4, wherein the environment data is obtained from at least one of a camera and a distance measurement device of the respective vehicle.

16. The multi-user navigation system according to claim 5, wherein the emergency navigation device is configured to transmit, via the mobile telecommunications system, the emergency route message to other emergency navigation devices each being associated with another emergency vehicle that is within a predetermined distance to the route of the emergency vehicle.

17. The multi-user navigation system according to claim 5, wherein the emergency navigation device is configured to transmit, via the mobile telecommunications system, the emergency route message to a plurality of public transport navigation devices each being associated with a public transport vehicle that is within a predetermined distance to the route of the emergency vehicle.

18. An information processing method for a multi-user navigation system, comprising:
determining, based on an obtained start location of an emergency vehicle and an obtained destination of the emergency vehicle, emergency route data representing an emergency route of the emergency vehicle from the start location to the destination;
transmitting, via a mobile telecommunications system, an emergency route message to a plurality of navigation devices each being associated with a vehicle that is within a predetermined distance to the route of the emergency vehicle; and
receiving the emergency route message which indicates that the emergency vehicle approaches.

19. The information processing method according to claim 18, wherein the emergency route message includes the emergency route data.

20. The information processing method according to claim 19, comprising:
determining, via vehicle-to-vehicle communications provided by the respective vehicle, a cooperative driving maneuver with the other of the plurality of navigation devices in response to the emergency route message for clearing the emergency route.
